(19) United States
(12) Patent Application Publication
(10) Pub. No.: US 2014/0339072 A1
(43) Pub. Date: Nov. 20, 2014

(54) Photocatalytic CO2 Reduction System

(71) Applicant: Sunpower Technologies LLC, San Marcos, CA (US)

(72) Inventors: Travis Jennings, San Diego, CA (US); Daniel Landry, Redondo Beach, CA (US)

(73) Assignee: Sunpower Technologies LLC, San Marcos, CA (US)

(21) Appl. No.: 13/896,987

(22) Filed: May 17, 2013

(51) Int. Cl. B01J 27/04; B01J 19/12

(52) U.S. Cl. CPC B01J 27/04; B01J 19/127
USPC 204/157.15; 422/186.04

(57) ABSTRACT

A system employing sunlight energy for reducing CO₂ into methane and water is disclosed. The system may include the use of a photoactive material including plasmonic nanoparticles and photocatalytic capped colloidal nanocrystals (PCCN). A method for producing the PCCN may include a semiconductor nanocrystal synthesis and an exchange of organic capping agents with inorganic capping agents. Additionally, the PCCN may be deposited between the plasmonic nanoparticles, and may act as photocatalysts for redox reactions. The CO₂ reduction system may use inorganic capping agents that cap the surface of semiconductor nanocrystals to form PCCN, which may be deposited on a substrate and treated to form a photoactive material. The photoactive material may be employed in the system to harvest sunlight and produce energy necessary for carbon dioxide reduction. The system may also include elements necessary to collect and transfer methane, for subsequent transformation into electrical energy.

### CROSS-REFERENCE TO RELATED APPLICATIONS

The disclosure here described is related to U.S. patent application Ser. No. 13/722,476, filed Dec. 20, 2012, “Photocatalytic System for the Reduction of Carbon Dioxide,” and U.S. patent application Ser. No. 13/837,412, filed Mar. 15, 2013, entitled “Method for Increasing Efficiency of Semiconductor Photocatalysts,” which are incorporated by reference herein in their entirety.

### BACKGROUND

1. Field of the Disclosure

The present disclosure relates generally to photocatalysis, and more specifically, to a system and method employing sunlight energy for the reduction of carbon dioxide using plasmonic nanoparticles and photocatalysts.

2. Background Information

Photoactive materials used for CO₂ reduction may require having a strong UV/visible light absorption, high chemical stability in the dark and under illumination, suitable band edge alignment to enable redox reactions, efficient charge transport in the semiconductors, and low overpotentials for redox reactions.

TiO₂ is by far the most widely investigated material due to its ready availability, low cost, lack of toxicity, and photostability. However, with the large band gap of 3.2 eV of TiO₂, only a small UV fraction (^{˜}2-3% of the solar spectrum) may be utilized. Significant research effort is aimed at sensitization of TiO₂ by shifting the optical absorption towards the visible part of the spectrum via doping. These attempts, however, have met with limited success.

Methods for fabricating photoactive materials from semiconductor nanoparticles for photocatalytic reactions also include the use of colloidal nanoparticles with organic, volatile ligands, which have insulating characteristics that may prevent a good separation of charge carriers for use in redox reactions, reducing light harvesting and energy conversion efficiencies.

Efforts to produce photocatalysts operating efficiently under visible light have led to a number of plasmonic photocatalysts, in which noble metal nanoparticles are deposited on the surface of polar semiconductor or insulator particles. In the metal-semiconductor composite photocatalysts, the noble metal nanoparticles act as a major component for harvesting visible light due to their surface plasmon resonance, while the metal-semiconductor interface efficiently separates the photogenerated electrons and holes. However, corrosion or dissolution of noble metal particles in the course of a photocatalytic reaction is very likely to limit the practical application of such systems.

There still exists a need for improvement in this field, including the need for development of improved materials and devices that may operate with higher energy conversion efficiency for producing photoactive materials.

### SUMMARY

According to various embodiments of the present disclosure, a composition and method for making a photoactive material including photocatalytic capped colloidal nanocrystals (PCCN) and plasmonic nanoparticles is disclosed. Here, the CO₂ reduction may be considered as a photocatalytic application.

A method for producing PCCN may include semiconductor nanocrystals synthesis and substituting organic capping agents with inorganic capping agents. The morphologies of semiconductor nanocrystals may include nanocrystals, nanorods, nanoplates, nanowires, dumbbell-like nanoparticles, and dendritic nanomaterials, among others. Each morphology may include an additional variety of shapes such as spheres, cubes, tetrahedra (tetrapods), among others. Varying sizes and shapes of PCCN may assist in tuning band gaps for absorbing different wavelengths of light.

A preparation of plasmonic nanoparticles may be performed separately from the formation of PCCN, and may include different methods known in the art, varying according to the different materials and desired shapes of noble metal nanoparticles to be used, reaction times, temperatures, and other factors. Nanoparticles of noble metals, such as Ag, Au, and Pt, may be used because noble metal nanoparticles are capable of absorbing visible light due to their localized surface plasmon resonance (LSPR), which may be tuned by varying their size, shape, and surrounding of the noble metal nanoparticles. Furthermore, noble metal nanoparticles may also work as an electron trap and active reaction sites, which may be beneficial in the use for photocatalytic reactions such as CO₂ reduction. Plasmonic nanoparticles may include any suitable shape, such as spherical (nanospheres), cubic (nanocubes), or wires (nanowires), among others.

After the preparation of plasmonic nanoparticles, a deposition of PCCN between plasmonic nanoparticles may take place upon suitable substrates. After both PCCN and plasmonic nanoparticles have been deposited on the substrate, a thermal treatment may be performed.

When light makes contact with the plasmonic nanoparticles, oscillations of free electrons may occur as a consequence of the formation of a dipole moment in the plasmonic nanoparticles due to action of energy from electromagnetic waves of incident light, leading to LSPR. Additionally, strong electric fields may be created with LSPR. Electric fields of adjacent plasmonic nanoparticles may interact with each other to facilitate charge separation for accelerating redox reactions used in CO₂ reduction.

The method for reducing carbon dioxide employing plasmonic nanoparticles may include first and second semiconductor nanocrystals. First semiconductor nanocrystal may be capped with first inorganic capping agent and may be employed as a reduction photocatalyst, while second semiconductor nanocrystal may be capped with second capping agent and may be employed as an oxidation photocatalyst. Semiconductor nanocrystals may be configured in different shapes such as tetrapod, spherical, core/shell, carbon nanotubes and nanorods. Examples of PCCN may include noble metals, niquel, copper, titanium dioxide, zinc sulfide, and mixtures thereof.

In order to form a photoactive material, photocatalytic capped colloidal nanocrystals may be applied onto a suitable porous substrate having a pore size sufficient to admit CO₂ and H₂ gas. Photoactive material may be placed inside a reaction vessel where carbon dioxide and hydrogen gas are introduced. Light from a light source, such as sunlight, enters reaction vessel so that a redox reaction may take place between photoactive material, carbon dioxide and hydrogen. Suitable light source may have a wavelength between 300 nm to about 1500 nm.

The methane gas produced with the present method, may be easily delivered as fuel for homes, businesses, and factories. Methane is also a basic raw material for many compounds which may be employed to produce thousands of products of everyday use, such as plastics. Therefore, the use of methane may help to decrease fossil fuel dependency.

In one embodiment, a method for reducing carbon dioxide comprises: forming photocatalytic capped colloidal nanocrystals, wherein each photocatalytic capped colloidal nanocrystal includes a first semiconductor nanocrystal capped with a first inorganic capping agent; forming plasmonic nanoparticles, wherein the plasmonic nanoparticles include noble metal nanoparticles; depositing the formed plasmonic nanoparticles onto a substrate; depositing the formed photocatalytic capped colloidal nanocrystals on the substrate between the plasmonic nanoparticles, wherein each photocatalytic capped colloidal nanocrystal is deposited between at least two plasmonic nanoparticles; and thermally treating the substrate, the photocatalytic capped colloidal nanocrystals, and the plasmonic nanoparticles; absorbing light with a frequency equal to or greater than a frequency of electrons oscillating against the restoring force of positive nuclei within the plasmonic nanoparticles to cause localized surface plasmon resonance, whereby the localized surface plasmon resonance creates an electric field between two adjacent plasmonic nanoparticles; and absorbing irradiated light with an energy equal to or greater than the band gap of the photocatalytic capped colloidal nanocrystals that causes electrons of the photocatalytic capped colloidal nanocrystals to migrate from the valance band of photocatalytic capped colloidal nanocrystals into the conduction band of the photocatalytic capped colloidal nanocrystals for use in a reduction reaction, wherein the electric field prevents the electrons from recombining into the valence band of the photocatalytic capped colloidal nanocrystals; reacting carbon dioxide and hydrogen with the photocatalytic capped colloidal nanocrystals so that the charge carriers in the conduction band reduce carbon dioxide into methane and holes in the valence band of the plasmonic nanoparticles oxidize the hydrogen into water vapor; and collecting the methane and water using a methane permeable membrane and a water vapor-permeable membrane.

In another embodiment, a carbon dioxide reduction system comprises: a photoactive material comprising: a substrate; a plurality of plasmonic nanoparticles deposited on the substrate, wherein the plasmonic nanoparticles create an electric field between two adjacent plasmonic nanoparticles when absorbing light; and a plurality of photocatalytic capped colloidal nanocrystals deposited on the substrate, wherein each photocatalytic capped colloidal nanocrystal is deposited between at least two plasmonic nanoparticles; a reaction vessel housing the photoactive material and configured to receive carbon dioxide from a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb light to separate charge carriers of the photoactive material; and a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

In another embodiment, a carbon dioxide reduction system comprises: a photoactive material comprising: a substrate; a plurality of plasmonic nanoparticles deposited on the substrate, wherein the plasmonic nanoparticles create an electric field between two adjacent plasmonic nanoparticles when absorbing light; and a plurality of photocatalytic capped colloidal nanocrystals deposited on the substrate, wherein each photocatalytic capped colloidal nanocrystal is deposited between at least two plasmonic nanoparticles; a boiler that produces carbon dioxide through a combustion reaction; a reaction vessel housing the photoactive material and configured to receive carbon dioxide from the boiler through a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb light to separate charge carriers of the photoactive material; and a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

Numerous other aspects, features of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 illustrates a flow diagram of a process for producing a photoactive material including photocatalytic capped colloidal nanocrystals (PCCN) and plasmonic nanoparticles, according to an exemplary embodiment.

FIG. 2A illustrates plasmonic nanoparticles exhibiting an edge-to-edge nanojunction, and FIG. 2B illustrates plasmonic nanoparticles exhibiting a face-to-face nanojunction, according to an exemplary embodiment.

FIG. 3A illustrates a PCCN positioned between plasmonic nanoparticles in the edge-to-edge nanojunction, and FIG. 3B illustrates a PCCN positioned between plasmonic nanoparticles in the face-to-face nanojunction, according to an exemplary embodiment.

FIG. 4 illustrates localized surface plasmon resonance (LSPR) occurring when the photoactive material reacts to light, according to an exemplary embodiment.

FIG. 5 illustrates a water splitting process that may occur when the photoactive material is submerged in water and makes contact with incident light, according to an exemplary embodiment.

FIG. 6A illustrates light contacting plasmonic nanoparticles to excite electrons into the valence band of the plasmonic nanoparticles into the conduction band of the PCCN as part of the charge separation process that may occur during water splitting, and FIG. 6B illustrates electrons reducing hydrogen from water, according to an exemplary embodiment.

FIG. 7 illustrates a carbon dioxide reduction system employing carbon dioxide reduction process, according to an exemplary embodiment.

FIG. 8 illustrates a PCCN in spherical shape, according to an exemplary embodiment.

FIG. 9 illustrates a PCCN in rod shape, according to an exemplary embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used herein, the following terms may have the following definitions:

“Carbon dioxide reduction” refers to the conversion of carbon dioxide to useful chemicals such as hydrocarbons or synthesis gas by reacting carbon dioxide with hydrogen/hydrogen containing compounds.

“Semiconductor nanocrystals” refers to particles sized between about 1 and about 100 nanometers made of semiconducting materials.

“Valence band” refers to an outermost electron shell of atoms in semiconductor or metal nanoparticles, in which electrons may be too tightly bound to an atom to carry electric current.

“Conduction band” refers to a band of orbitals that are high in energy and generally empty.

“Band gap” refers to an energy difference between a valence band and a conduction band within semiconductor or metal nanoparticles.

“Inorganic capping agent” refers to semiconductor particles excluding organic materials and which may cap semiconductor nanocrystals.

“Organic capping agent” refers to materials excluding inorganic substances, which may assist in a suspension and/or solubility of a semiconductor nanocrystal in solvents.

“Photoactive material” refers to a substance capable of performing catalytic reactions in response to light.

“Localized surface plasmon resonance”, or “LSPR”, refers to a phenomenon in which conducting electrons on noble metal semiconductor nanoparticles undergo a collective oscillation induced by an oscillating electric field of incident light.

“Dipole moment” refers to a measure of a separation of positive and negative electrical charges within materials.

“Sensitivity to light” refers to a property of materials that when exposed to photons typically within a visible region, such as of about 400 nm to about 750 nm, LSPR may be excited.

### DESCRIPTION OF THE DRAWINGS

The present disclosure relates to a system for the reduction of carbon dioxide into methane and water. The carbon dioxide reduction system may employ a plasmon-induced enhancement of catalytic properties of semiconductor photocatalysts, in which photocatalytic capped colloidal nanocrystals (PCCN) may be deposited between plasmonic nanoparticles within a photoactive material. The plasmonic metal nanoparticles may react to incident light to create a very intense electric field between two adjacent plasmonic metal nanoparticles, initiated by surface plasmon resonance. These intense electric fields may enhance the production of charge carriers by the plasmonic nanoparticles for use in redox reactions necessary for photocatalytic CO₂ reduction to occur, and may also improve the catalytic properties of the PCCN.

Both the plasmonic metal nanoparticles and the PCCN may first be produced separately and subsequently combined, deposited on a substrate, and thermally treated for forming the photoactive material.

Photoactive Material Formation

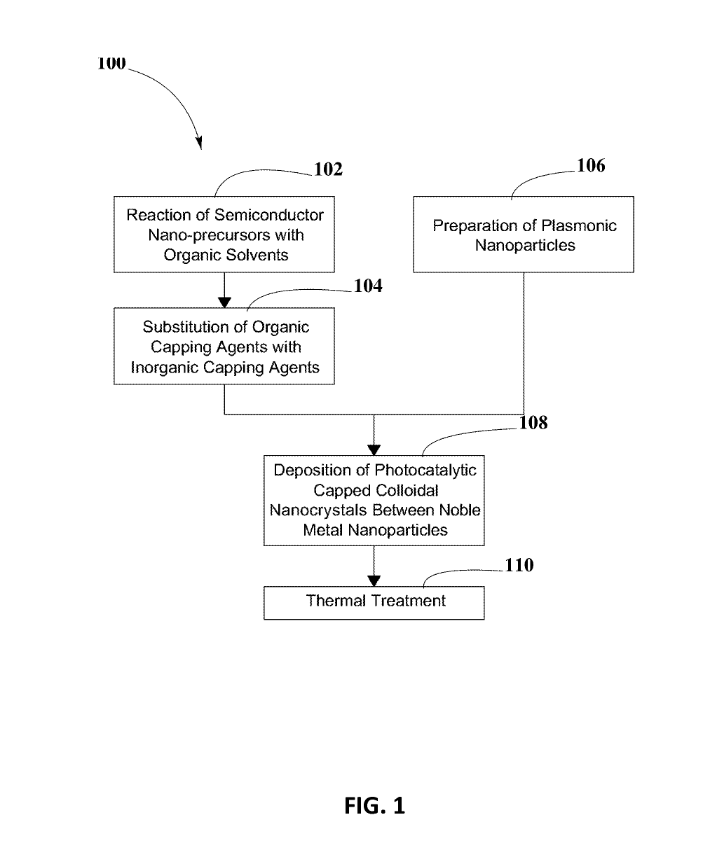

FIG. 1 is a flow diagram for a method for forming a photoactive material 100. To form a composition of PCCN that may be included in the photoactive material, semiconductor nanocrystals may first be formed, for which known synthesis techniques via batch or continuous flow wet chemistry processes may be employed. These known techniques may include a reaction of semiconductor nano-precursors with organic solvents 102, which may involve capping semiconductor nanocrystal precursors in a stabilizing organic material, or organic ligands, referred to in this description as an organic capping agent, for preventing agglomeration of the semiconductor nanocrystals during and after reaction of semiconductor nano-precursors with organic solvents 102. Additionally, the long organic chains radiating from organic capping agents on the surface of semiconductor nanocrystals may assist in suspending or dissolving those nanocrystals in a solvent. One example of an organic capping agent may be trioctylphosphine oxide (TOPO), which may be used in the manufacture of CdSe, among other semiconductor nanocrystals. TOPO 99% may be obtained from Sigma-Aldrich (St. Louis, Mo.). TOPO capping agent prevents the agglomeration of semiconductor nanocrystals during and after their synthesis. Suitable organic capping agents may also include long-chain aliphatic amines, long-chain aliphatic phosphines, long-chain aliphatic carboxylic acids, long-chain aliphatic phosphonic acids and mixtures thereof.

The chemistry of capping agents may control several system parameters. For example, varying the size of semiconductor nanocrystals may often be achieved by changing the reaction time, reaction temperature profile, or structure of the organic capping agent used to passivate the surface of semiconductor nanocrystals during growth. Other factors may include growth rate or shape, the dispersability in various solvents and solids, and even the excited state lifetimes of charge carriers in semiconductor nanocrystals. The flexibility of synthesis is demonstrated by the fact that often one capping agent may be chosen for its growth control properties, and then later a different capping agent may be substituted to provide a more suitable interface or to modify optical properties or charge carrier mobility. As known in the art, a number of synthetic routes for growing semiconductor nanocrystals may be employed, such as a colloidal route, as well as high-temperature and high-pressure autoclave-based methods. In addition, traditional routes using high temperature solid state reactions and template-assisted synthetic methods may be used.

Examples of semiconductor nanocrystals may include the following: AlN, AlP, AlAs, Ag, Au, Bi, Bi₂S₃, Bi₂Se₃, Bi₂Te₃, CdS, CdSe, CdTe, Co, CoPt, CoPt₃, Cu, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Pd, Pt, Ru, Rh, Si, Sn, ZnS, ZnSe, ZnTe, and mixtures thereof. Additionally, examples of applicable semiconductor nanocrystals may further include core/shell semiconductor nanocrystals such as Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O₄, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods such as CdSe; core/shell nanorods such as CdSe/CdS; nano-tetrapods such as CdTe, and core/shell nano-tetrapods such as CdSe/CdS.

The morphologies of semiconductor nanocrystals may include nanocrystals, nanorods, nanoplates, nanowires, dumbbell-like nanoparticles, and dendritic nanomaterials. Each morphology may include an additional variety of shapes such as spheres, cubes, and tetrahedra (tetrapods), among others. Neither the morphology nor the size of semiconductor nanocrystals may inhibit method for forming a photoactive material 100; rather, the selection of morphology and size of semiconductor nanocrystals may permit the tuning and control of the properties of PCCN. The semiconductor nanocrystals may have a diameter between about 1 nm and about 1000 nm, although typically they are in the 2 nm-10 nm range. Due to the small size of the semiconductor nanoparticles, quantum confinement effects may manifest, resulting in size, shape, and compositionally dependent optical and electronic properties, versus properties for the same materials in bulk scale.

Following reaction of semiconductor nano-precursors with organic solvents 102, a substitution of organic capping agents with inorganic capping agents 104 may take place. There, organic capped semiconductor nanocrystals in the form of a powder, suspension, or a colloidal solution, may be mixed with inorganic capping agents, causing a reaction of organic capped semiconductor nanocrystals with inorganic capping agents. This reaction may rapidly produce insoluble and intractable materials. Then, a mixture of immiscible solvents may be used to control the reaction, facilitating a rapid and complete exchange of organic capping agents with inorganic capping agents. During this exchange, organic capping agents are released.

Generally, inorganic capping agents may be dissolved in a polar solvent, while organic capped semiconductor nanocrystals may be dissolved in an immiscible, generally non-polar, solvent. These two solutions may then be combined and stirred for about 10 minutes, after which a complete transfer of semiconductor nanocrystals from the non-polar solvent to the polar solvent may be observed. Immiscible solvents may facilitate a rapid and complete exchange of organic capping agents with inorganic capping agents.

Organic capped semiconductor nanocrystals may react with inorganic capping agents at or near the solvent boundary, where a portion of the organic capping agent may be exchanged/replaced with a portion of the inorganic capping agent. Thus, inorganic capping agents may displace organic capping agents from the surface of semiconductor nanocrystals, and inorganic capping agents may bind to that semiconductor nanocrystal surface. This process may continue until an equilibrium is established between inorganic capping agents and the free inorganic capping agents. Preferably, the equilibrium favors inorganic capping agents. All the steps described above may be carried out in a nitrogen environment inside a glove box.

The purification of inorganic capped semiconductor nanocrystals may require an isolation procedure, such as the precipitation of inorganic product. That precipitation permits one of ordinary skill to wash impurities and/or unreacted materials out of the precipitate. Such isolation may allow for the selective application of PCCN.

Preferred inorganic capping agents for PCCN may include polyoxometalates and oxometalates, such as tungsten oxide, iron oxide, gallium zinc nitride oxide, bismuth vanadium oxide, zinc oxide, titanium dioxide, among others. As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi 33−, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻Sb₄²⁻, Sb₇³⁻, SbSe₄³⁻, SbSe₄⁵⁻, SbTe₄⁵⁻, Sb₂Se₃⁻, Sb₂Te₅⁴⁻, Sb₂Te₇⁴⁻, Sb₄Te₄⁴⁻, Sb₉Te₆³⁻, Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, SnS₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TlTe₂²⁻, and mixed metal SnS₄Mn₂⁵⁻, among others. The positively charged counter ions may be alkali metal ions, ammonium, hydrazinium, tetraalkylammmonium, among others.

Further embodiments may include other inorganic capping agents. For example, inorganic capping agents may include molecular compounds derived from CuInSe₂, CuInₓGa₁₋ₓSe₂, Ga₂Se₃, In₂Se₃, In₂Te₃, Sb₂S₃, Sb₂Se₃, Sb₂Te₃, and ZnTe.

Still further, inorganic capping agents may include mixtures of Zintl ions and molecular compounds.

These inorganic capping agents further may include transition metal chalcogenides, examples of which may include the tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, such as MoS(Se₄)₂²⁻, Mo₂S₆²⁻, among others.

Method for forming a photoactive material 100 may be adapted to produce a wide variety of PCCN.

Adaptations of this method for forming a photoactive material 100 may include adding two different inorganic capping agents to a single semiconductor nanocrystals (e.g., Au.(Sn₂S₆;In₂Se₄); Cu₂Se.(In₂Se₄;Ga₂Se₃)), adding two different semiconductor nanocrystals to a single inorganic capping agent (e.g., (Au;CdSe).Sn₂S₆; (Cu₂Se;ZnS).Sn₂S₆), adding two different semiconductor nanocrystals to two different inorganic capping agents (e.g., (Au;CdSe).(Sn₂S₆;In₂Se₄)), and/or additional multiplicities.

The sequential addition of inorganic capping agents to semiconductor nanocrystals may be possible under the disclosed method for forming a photoactive material 100. Depending, for example, upon concentration, nucleophilicity, bond strength between capping agents and semiconductor nanocrystal, and bond strength between semiconductor nanocrystal face dependent capping agent and semiconductor nanocrystal, inorganic capping of semiconductor nanocrystals may be manipulated to yield other combinations.

Suitable PCCN may include Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, Fe Pt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄ FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

As used in the present disclosure, the denotation Au.Sn₂S₆ may refer to an Au semiconductor nanocrystal capped with a Sn₂S₆ inorganic capping agent. Charges on the inorganic capping agent are omitted for clarity. This notation [semiconductor nanocrystal]. [inorganic capping agent] is used throughout this description. The specific percentages of semiconductor nanocrystals and inorganic capping agents may vary between different types of PCCN.

Preparation of plasmonic nanoparticles 106 may be a process performed separately from reaction of semiconductor nano-precursors with organic solvents 102. According to various embodiments of the present disclosure, different methods known in the art for preparation of plasmonic nanoparticles 106 may be employed, which may vary according to the different materials and desired shapes of the noble metal nanoparticles to be used, reaction times, temperatures, and other factors. Nanoparticles of noble metals, such as Ag, Au, and Pt, may be used in preparation of plasmonic nanoparticles 106 because noble metal nanoparticles are capable of absorbing visible light due to their localized surface plasmon resonance, which may be tuned by varying their size, shape, and surrounding of the noble metal nanoparticles. Furthermore, noble metal nanoparticles may also work as an electron trap and active reaction sites, which may be beneficial in the use for photocatalytic reactions used for CO₂ reduction.

Plasmonic nanoparticles may include any suitable shape, but generally shapes employed may include spherical (nanospheres), cubic (nanocubes), or wire (nanowires), among others. The shapes of these plasmonic nanoparticles may be obtained by various synthesis methods. For example, Ag plasmonic nanoparticles of various shapes may be formed by the reduction of silver nitrate with ethylene glycol in the presence of poly(vinyl pyrrolidone) (“PVP”). Ag nanocubes may be obtained by adding silver nitrate in ethylene glycol at a concentration of about 0.25 mol/dm3 and PVP in ethylene glycol at a concentration of about 0.375 mol/dm3 to heated etheylene glycol and allowing the reaction to proceed at a reaction temperature of about 160° C. The injection time may be of about 8 min, the unit of volume may be of about one milliliter (mL), and the reaction time may be of about 45 minutes.

According to embodiments of the present disclosure, approaches for preparation of plasmonic nanoparticles 106 may include depositing noble metal nanoparticles on the surface of a suitable polar semiconductor, such as AgCl, N—TiO₂ or AgBr, to form a metal-semiconductor composite plasmonic nanoparticle photocatalyst. In this embodiment, the noble metal nanoparticles may strongly absorb visible light, and the photogenerated electrons and holes of the noble metal nanoparticles may be efficiently separated by the metal-semiconductor interface.

As another example embodiment, a procedure for obtaining Au plasmonic nanoparticles embedded in SiO₂/TiO₂ thin films is described, where Au may function as the noble metal nanoparticle and SiO₂/TiO₂ as the semiconductors included in the plasmonic nanoparticles. In this embodiment, Au plasmonic nanoparticles may first be deposited onto a substrate, and the PCCN may be deposited subsequently. Initially, an ethanolic solution of the SiO₂/TiO₂ precursor and poloxamer (e.g. PluronicP123—poly(ethylene oxide)-poly(propylene oxide)-poly(ethyleneoxide) (PEO-PPO-PEO) triblock copolymer) may be spin coated onto a Si or glass substrate. Then, a solution of HAuCl₄ may be deposited dropwise onto the surface and the sample may be spun again. Finally, the resulting film may be baked at about 350° C. for about 5 min. During the bake, a significant color change may take place because of the incorporation of Au nanoparticles in the host matrix.

The formation of inorganic matrices between the Au nanoparticle and the SiO₂/TiO₂ may be based on the acid-catalysed hydrolytic polycondensation of metal alkoxides such as tetraethyl orthosilicate (SiO₂ precursor) and titanium tetrai-sopropoxide (TTIP; TiO₂ precursor) in the presence of poloxamer, which may be used to achieve homogeneous, mesoporous spin-coated thin films. Moreover, the poloxamer may play a key role on the incorporation of the AuCl₄-ions (Au nanoparticle precursor) into the host matrix because the PEO in poloxamer may form cavities (pseudo-crownethers) that may efficiently bind metal ions. Furthermore, the PEO and PPO blocks in poloxamer may act as reducing agents of AuCl₄ for the in situ synthesis of Au nanoparticles. Additionally, the formation of ethanol and isopropanol as byproducts of the respective TEOS (tetraethylorthosilicate, Si(OCH₂CH₃)₄ and TTIP polycondensations may also facilitate the reduction of Au(III).

The nanocomposite thin film formed by the above described method may have a surface roughness of about 10 to about 30 nm, depending on the size of Au nanoparticles produced in the metal oxide matrix, which may be determined by the concentration of Au(III) in the precursor solution.

After preparation of plasmonic nanoparticles 106, a deposition of PCCN between plasmonic nanoparticles 108 may take place. According to an embodiment, deposition of PCCN between plasmonic nanoparticles 108 may include first depositing plasmonic nanoparticles over a substrate, and then depositing the composition of PCCN over the substrate. According to another embodiment, PCCN may first be deposited over the substrate, followed by the deposition of PCCN over the substrate. According to yet another embodiment, both the composition of plasmonic nanoparticles and the composition of PCCN may be mixed and deposited over the substrate. Deposition methods over substrates may include spraying deposition, sputter deposition, electrostatic deposition, spin coating, inkjet deposition, and laser printing (matrices), among others.

According to various embodiments of the present disclosure, suitable substrates that may be used in the present disclosure may include porous substrates, which may additionally be optically transparent in order to allow plasmonic nanoparticles and PCCN to receive more light. These suitable porous substrates may include glass frits, fiberglass cloth, porous alumina, and porous silicon. Furthermore, suitable porous substrate may have a pore size sufficient for carbon dioxide to pass though at a constant flow rate. However, according to another embodiments, deposition on porous substrate may not be needed, where plasmonic nanoparticles and PCCN may be deposited into a crucible and then annealed.

After both plasmonic nanoparticles and PCCN have been deposited over the substrate, a thermal treatment 110 may take place, which may result in the formation of a photoactive material for use in photoacatalytic reactions. Many of the inorganic capping agents used in PCCN may be precursors to inorganic materials (matrices), thus a low-temperature thermal treatment 110 of the inorganic capping agents employing a convection heater may provide a gentle method to produce crystalline films including both PCCN and plasmonic nanoparticles. Thermal treatment 110 may yield, for example, ordered arrays of semiconductor nanocrystals within an inorganic matrix, hetero-alloys, or alloys. In at least one embodiment, the convection heater may reach temperatures less than about 350, 300, 250, 200, and/or 180° C.

Plasmonic Nanoparticles and PCCN Alignment

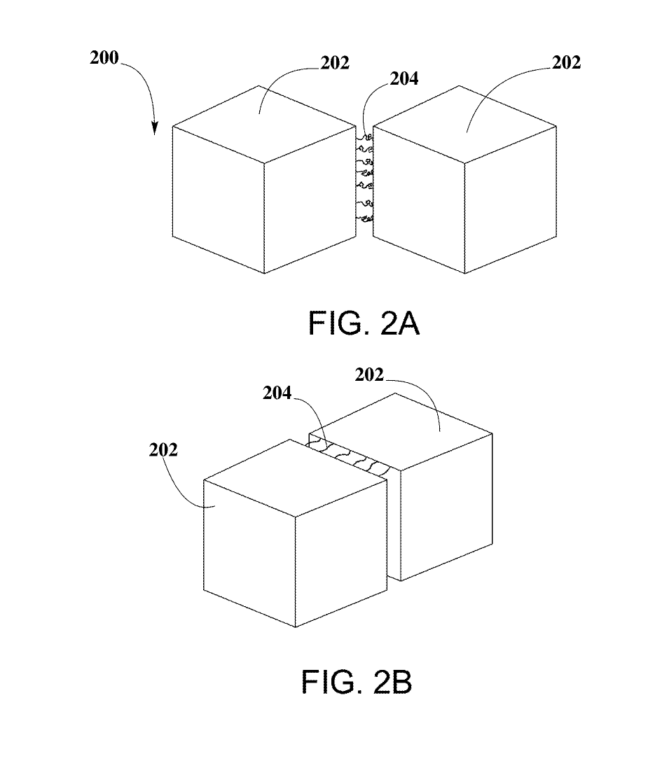

FIGS. 2A and 2B illustrate embodiments of alignment of plasmonic nanoparticles 200 within the photoactive material.

FIG. 2A shows plasmonic nanoparticles 202 in cubic shape exhibiting an edge-to-edge nanojunction employing ligands 204. In FIG. 2B, plasmonic nanoparticles 202 in cubic shape exhibit a face-to-face orientation, also employing ligands 204.

Benefits of using cubic shaped plasmonic nanoparticles 202 may include that cubes may be a compelling geometry for constructing non-close-packed nanoparticle architectures by coordination through facet, corner, or edge sites, and that this shape may support the excitation of higher-order surface plasmon modes occurring through charge localization into the corners and edges of the plasmonic nanoparticles 202. This excitation may enable orientation-dependent electromagnetic coupling between neighboring plasmonic nanoparticles 202, where interparticle junctions formed by cube corners and edges may produce intense electromagnetic fields.

Different methods may be used to align plasmonic nanoparticles 202 in the desired manner. For example, to achieve an edge-to-edge nanojunction, cubic plasmonic nanoparticles 202 may be grafted with a long, floppy polymer ligand such as poly(vinyl pyrrolidone) (PVP, Mw ¼ 55,000) and embedded within a polystyrene (Mw ¼ 10,900) thin film with a thickness of about 150 nm. As the film is annealed using thermal or solvent vapor treatment, plasmonic nanoparticles 202 may assemble in the edge-to-edge nanojunction to form strings that may continuously grow and converge.

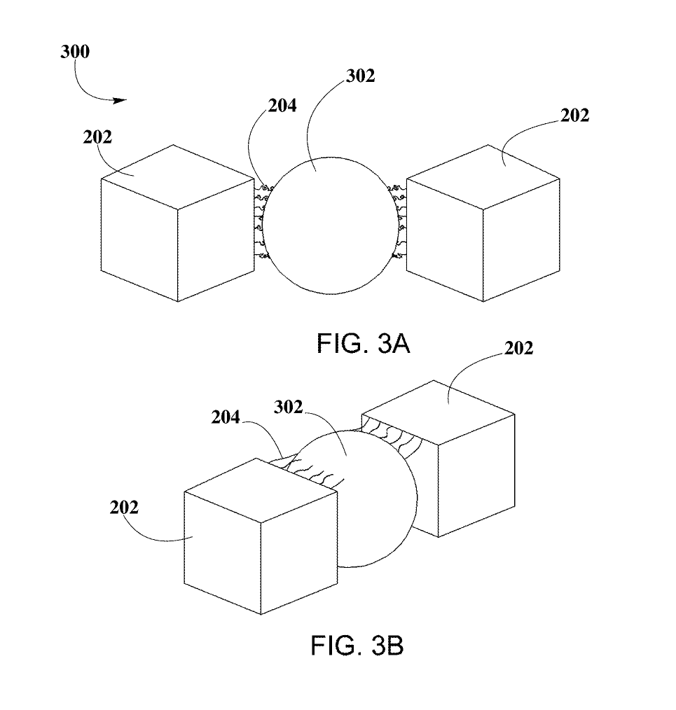

FIGS. 3A and 3B show different embodiments for positioning of PCCN between plasmonic nanoparticles 300 within the photoactive material.

FIG. 3A shows PCCN 302 in spherical shape positioned between plasmonic nanoparticles 202 in edge-to-edge nanojunction employing ligands 204. FIG. 3B shows PCCN 302 positioned between plasmonic nanoparticles 202 in face-to-face nanojunction employing ligands 204. Other arrangements, shapes, and different sizes and elements may be considered when depositing PCCN 302 between plasmonic nanoparticles 202. Additionally, methods other than binding PCCN 302 to plasmonic nanoparticles 202 with ligands 204 may be employed, such as depositing PCCN 302 at stoichiometrically higher ratios so that statistics guides their chances of appropriate orientation.

Ligands 204 may be self-organizing molecules. For example, ligands 204 may be generated using self assembling monolayer components. Typically, complementary binding pairs employed in ligands 204 are molecules having a molecular recognition functionality. For example, ligands 204 may include an amine-containing compound and a ketone or alcohol-containing compound.

Ligands 204 may be associated, either directly or indirectly, with any of a number of suitable nanostructure shapes and sizes, such as spherical, ovoid, elongated, or branched structures. Ligands 204 may either be directly associated with the surface of a nanostructure, or indirectly associated, through a surface ligand on the nanostructure; this interaction may be, for example, an ionic interaction, a covalent interaction, a hydrogen bond interaction, an electrostatic interaction, a coulombic interaction, a van der Waals force interaction, or a combination thereof. Optionally, the chemical composition of ligands 204 may include one or more functionalized head groups capable of binding to a nanostructure surface, or to an intervening surface ligand. Chemical functionalities that may be used as a functionalized head group may include one or more phosphonic acid, carboxylic acid, amine, phosphine, phosphine oxide, carbamate, urea, pyridine, isocyanate, amide, nitro, pyrimidine, imidazole, salen, dithiolene, catechol, N,O-chelate ligand (such as ethanol amine or aniline phosphinate), P,N-chelate ligand, and/or thiol moieties.

Localized Surface Plasmon Resonance (LSPR)

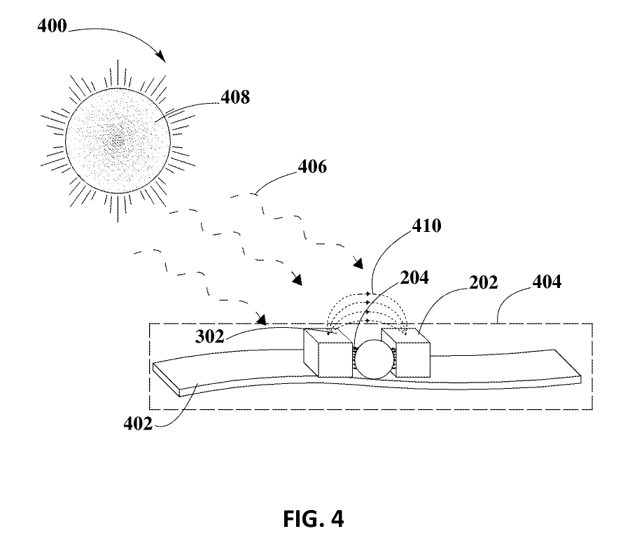

FIG. 4 shows LSPR of photoactive material 400. Accordingly, PCCN 302 may be located between plasmonic nanoparticles 202 deposited over a substrate 402 for forming a photoactive material 404.

When light 406 emitted from a light source 408 makes contact with plasmonic nanoparticles 202, oscillations of free electrons may occur as a consequence of the formation of a dipole moment in plasmonic nanoparticles 202 due to action of energy from electromagnetic waves of incident light 406. The electrons may migrate in plasmonic nanoparticles 202 to restore plasmonic nanoparticles 202 initial electrical state. However, light waves may constantly oscillate, leading to a constant shift in the dipole moment of plasmonic nanoparticles 202, thus electrons may be forced to oscillate at the same frequency as light 406, a process known as LSPR.

LSPR may only occur when frequency of light 406 is equal to or less than frequency of surface electrons oscillating against the restoring force of positive nuclei within plasmonic nanoparticles 202. LSPR may be considered greatest at the electron plasma frequency of plasmonic nanoparticles 202, which is referred to as the resonant frequency. In plasmonic nanoparticles 202, the resonant frequency may be tuned by changing the geometry and size of plasmonic nanoparticles 202. The intensity of resonant electromagnetic radiation may be enhanced by several orders of magnitude near the surface of plasmonic nanoparticles 202. Additionally, LSPR of photoactive material 400 may create strong electric fields 410 between plasmonic nanoparticles 202. These electric fields 410 may closely interact with each other in adjacent plasmonic nanoparticles 202, which may increase formation of charge carriers for use in redox reactions required for CO2 reduction and enhance efficiency of these photocatalytic reactions.

Intensity of LSPR and electric field 410 may depend on wavelength of light 406 employed, as well as on materials, shapes, and sizes of plasmonic nanoparticles 202. These properties may be related to the densities of free electrons in the noble metals within plasmonic nanoparticles 202. Suitable materials used for plasmonic nanoparticles 202 may include those that are sensitive to visible light 406, although, according to other embodiments and depending on the wavelength of light 406, materials that are insensitive to visible light 406 may also be employed.

For example, the densities of free electrons in Au and Ag nanoparticles may be considered to be in the proper range to produce LSPR peaks in the visible part of the optical spectrum. For spherical gold and silver nanoparticles of about 1 to about 20 nm in diameter, only dipole plasmon resonance may be involved, displaying a strong LSPR peak of about 510 nm and about 400 nm, respectively.

According to various embodiments of the present disclosure, any suitable light source 408 may be employed to provide light 406. A suitable light source 408 may be sunlight, which includes infrared light, ultraviolet light, and visible light. Sunlight may be diffuse, direct, or both. Light 406 may be filtered or unfiltered, modulated or unmodulated, attenuated or unattenuated. Light 406 may also be concentrated to increase the intensity using a light intensifier (not shown in FIG. 4), which may include any combination of lenses, mirrors, waveguides, or other optical devices. The increase in the intensity of light 406 may be characterized by an intensity of light 406 having from about 300 to about 1500 nm (e.g., from about 300 nm to about 800 nm) in wavelength. A light intensifier may increase the intensity of light 406 by any factor, preferably by a factor greater than about 2, more preferably a factor greater than about 10, and most preferably a factor greater than about 25.

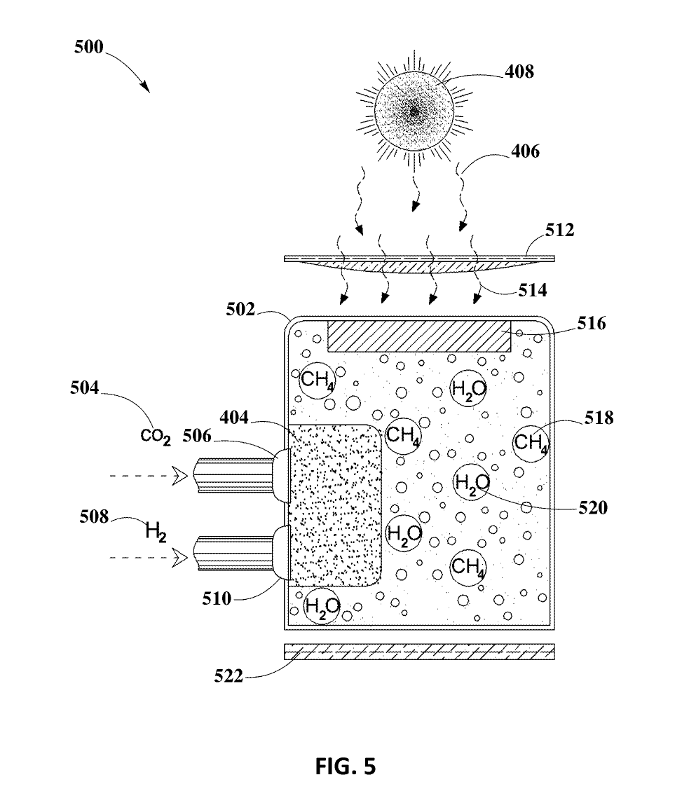

FIG. 5 represents carbon dioxide reduction process 500, where photoactive material 404 is located within reaction vessel 502. Carbon dioxide 504 may be introduced into reaction vessel 502 via inlet line 506. Similarly, hydrogen gas 508 may be injected into reaction vessel 502 by inlet line 510.

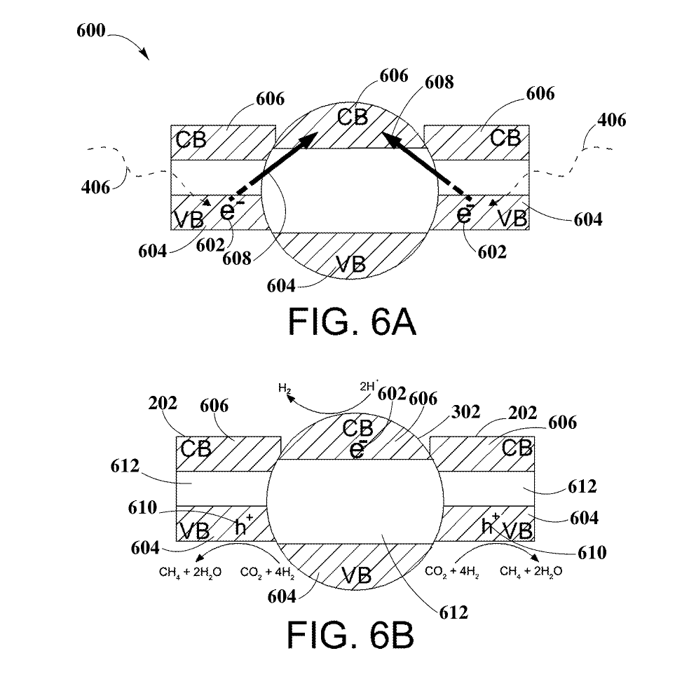

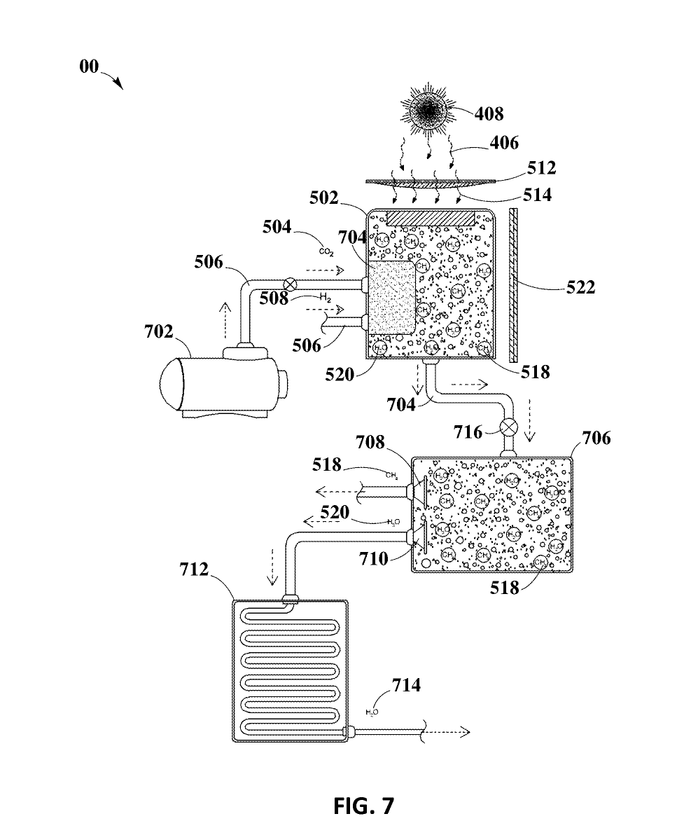

Light 406 from light source 408 may be intensified by light intensifier 512, which can be a solar concentrator, such as a parabolic solar concentrator. Light intensifier 512 may reflect light 406 and may direct intensified light 514 into reaction vessel 502 through window 516. Carbon dioxide 504 and hydrogen gas 508 may pass through photoactive material 404 prior to entering reaction vessel 502. Intensified light 514 may react with photoactive material 404 to produce charge separation (explained in FIG. 6) in the boundary of photoactive material 404. Carbon dioxide 504 may be reduced and hydrogen gas 508 may be oxidized by a series of reactions until methane molecule 518 and water vapor 520 are produced (explained in FIG. 7).

According to an embodiment, solar reflector 522 may be positioned at the bottom or any side of reaction vessel 502 to reflect intensified light 514 back to reaction vessel 502 to re-utilize it.

According to various embodiments, one or more walls of reaction vessel 502 may be formed of glass or other transparent material, so that intensified light 514 may enter reaction vessel 502 to react with photoactive material 404. Alternatively, reaction vessel 502 may have one transparent side to allow intensified light 514 to enter, while the other sides may have a reflective interior surface to reflect the majority of intensified light 514 into photoactive material 404.

A preferable light source 408 to provide light 406 for carbon dioxide reduction process 500 may be sunlight, including infrared, ultraviolet and visible light. Sunlight may be diffused, direct light, or both, or it may be filtered or unfiltered, modulated or unmodulated, attenuated or unattenuated. Preferably, light 406 may be concentrated to increase the intensity using light intensifier 512, which may include any combination of lenses, mirrors, waveguides, or other optical devices, to increase the intensity of light 406. The intensification occurs primarily at wavelengths from about 300 to about 1500 nm, and most particularly from about 300 nm to about 800 nm. Light intensifier 512 preferably increase the intensity of light 406 in a factor greater than about 2, more preferably a factor greater than about 10, and most preferably a factor greater than about 25.

FIGS. 6A and 6B show charge separation 600 that may occur during carbon dioxide reduction process 500.

In FIG. 6A, when light 406 with a frequency that is equal to or less than frequency of surface electrons 602 oscillating against the restoring force of positive nuclei within plasmonic nanoparticles 202, and with energy equal to or greater than that of band gap 612 of plasmonic nanoparticles 202, makes contact with plasmonic nanoparticles 202, electrons 602 may be excited and may migrate from valence band 604 of plasmonic nanoparticles 202 to conduction band 606 of PCCN 302. This process may be triggered by photo-excitation 608 and enhanced by the rapid electron 602 resonance from LSPR.

In FIG. 6B, when electrons 602 are in conduction band 606 of PCCN 302, electrons 602 may reduce carbon dioxide 504 into methane molecule 518, while hydrogen gas 508 may be oxidized by holes 610 left behind in valence band 604 of plasmonic nanoparticles 202. Accordingly, in order for carbon dioxide reduction process 500 to take place, photo-excited electrons 602 from plasmonic nanoparticles 202 may need to have a reduction potential greater than or equal to that necessary to drive the following chemical reactions:

CO₂+2H⁺+2e⁻→HCOOH (1)

HCOOH+2H⁺+2e⁻→HCHO+H2O (2)

HCHO+2H⁺+2e⁻→CH3OH (3)

CH3OH+2H⁺+2e⁻→CH₄+H2O (4)

During the carbon dioxide reduction process 500, as electrons 602 (e⁻) may be obtained from the reaction between carbon dioxide 504, PCCN, plasmonic nanoparticles, and hydrogen atoms (H⁺) may be obtained from hydrogen gas 508. Beginning from adsorbed carbon dioxide 504, formic acid (HCOOH) is formed (1) by accepting two electrons 602 (2e⁻) and adding two hydrogen atoms (2H⁺). Then, formaldehyde (HCHO) and water molecules (H2O) are formed (2) from the reduction of formic acid by accepting two electrons 602 (2e⁻) and adding two hydrogen atoms (2H⁺). Subsequently, methanol (CH3OH) is formed (3) when formaldehyde (HCHO) accepts two electrons 602 (2e⁻) and hydrogen atoms (2H⁺) are added to formaldehyde (HCHO). Finally, methane molecule 518 (CH₄) is formed (4) when methanol (CH3OH) accepts two electrons 602 (2e⁻) and two hydrogen atoms (2H⁺) are added to methanol (CH3OH). In addition, water (H2O) is formed as a byproduct of the reaction.

The reduction of carbon dioxide 504 to methane molecule 518 requires eight electrons 602 for the reduction of the chemical state of carbon from C (4+) to C (4−) for the production of each methane molecule 518. Taken as a whole, eight hydrogen atoms (H⁺) and eight electrons 602 progressively transfer to one adsorbed carbon dioxide 504 molecule, producing one methane molecule 518. Similarly, oxygen released from carbon dioxide 504 may react with free hydrogen radicals and form water vapor 520 molecules.

Electrons 602 may acquire energy corresponding to the wavelength of the absorbed light 406. Upon being excited, electrons 602 may relax to the bottom of conduction band 606, which may lead to recombination with holes 610 and therefore to an inefficient process for carbon dioxide reduction process 500. For an efficient charge separation 600, reactions have to take place to quickly sequester and hold electrons 602 and holes 610 for use in subsequent redox reactions used for carbon dioxide reduction process 500. For this purpose, the combined use of plasmonic nanoparticles 202 with enhanced electric fields 410 and LSPR, and the use of efficient PCCN 302 for accelerating redox reactions, may prevent recombination of charge carriers and may lead to an enhanced carbon dioxide reduction process 500.

Band gap 612 of energy of plasmonic nanoparticles 202 and PCCN 302 may be strongly size-and-shape dependent since these effects may determine absolute positions of the energy quantum-confined states in both plasmonic nanoparticles 202 and PCCN 302. The ability to efficiently inject or extract charge carriers may depend on the energy barriers that form at the interfaces between individual plasmonic nanoparticles 202 and also at the interface between PCCN 302 and plasmonic nanoparticles 202. If contacts do not properly align, a potential barrier may form, leading to poor charge injection and nonohmic contacts.

FIG. 7 represents carbon dioxide reduction system 700 employing carbon dioxide reduction process 500. Carbon dioxide reduction system 700 may operate in conjunction with a combustion system that produces carbon dioxide 504 as a byproduct. This system may be employed to take advantage of carbon dioxide 504 produced by one or more boilers 702 during a manufacturing process. Boiler 702 may be connected to reaction vessel 502 by inlet line 506 to allow a continuous flow of carbon dioxide 504 gas. Subsequently, carbon dioxide 504 may pass through photoactive material 404. Similarly, hydrogen gas 508 may also be injected into reaction vessel 502 via inlet line 510. Optionally, a heater (not shown) may be employed to increase the temperature in reaction vessel 502.

Following chemical reactions described above in FIG. 6B, the produced methane molecule 518 and water vapor 520 may exit reaction vessel 502 through outlet line 704 and enter collector 706, where a methane-permeable membrane 708 and a water vapor permeable membrane 710 may collect methane molecules 518 and water vapor 520, respectively. In one embodiment, the membranes may be a polymide resin membrane and a polydimethylsiloxane membrane, respectively. The collected methane molecules 518 may be subsequently stored in any suitable storage medium, or it may be directly used as fuel by boiler 702. The collected water vapor 520 may be transferred to water condenser 712 through outlet line 704 to obtain liquid water 714. Valves 716, pumps or monitoring devices may be added in order to measure and regulate pressure and/or flow rate. The flow rate of carbon dioxide 504 and hydrogen gas 508 into reaction vessel 502 may be adjusted depending on reaction time between carbon dioxide 504, hydrogen gas 508, and photoactive material 404. Optionally, a gas sensor device (not shown) may be attached to collector 706 to identify any methane molecule 518 leakage. Liquid water 714 may be employed for different purposes in the manufacturing process.

While various aspects and embodiments have been disclosed, other aspects and embodiments are contemplated. The various aspects and embodiments disclosed are for purposes of illustration and are not intended to be limiting, with the true scope and spirit being indicated by the following claims.

### EXAMPLES

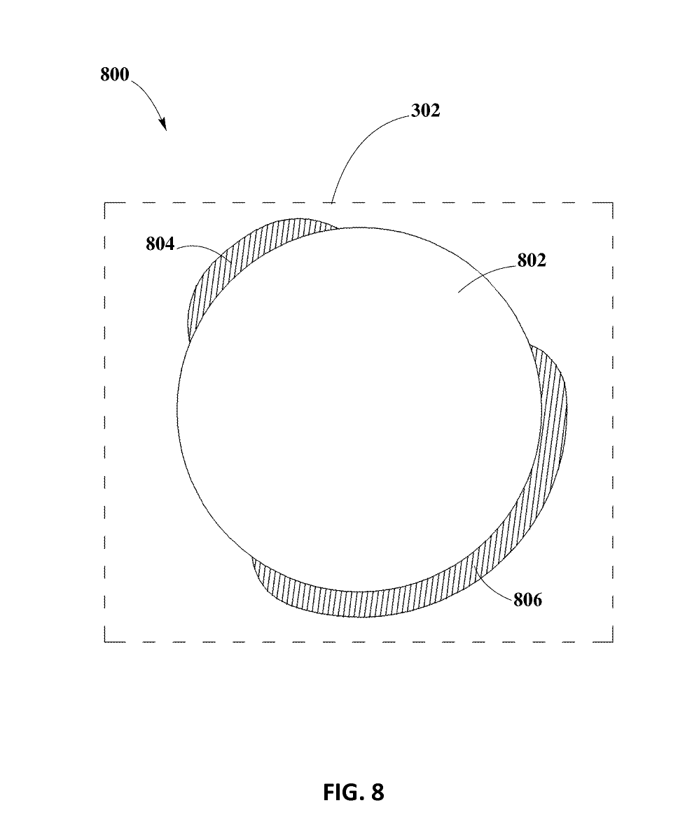

Example #1 is an embodiment of PCCN 302 in spherical shape 800, as shown in FIG. 8, which may include a single semiconductor nanocrystal 802 capped with a first inorganic capping agent 804 and a second inorganic capping agent 806.

In an embodiment, single semiconductor nanocrystal 802 may be PbS quantum dots, with SnTe₄⁴⁻ used as first inorganic capping agent 804 and AsS₃³⁻ used as second inorganic capping agent 806, therefore forming a PCCN 302 represented as PbS.(SnTe₄;AsS₃).

The shape of semiconductor nanocrystals 802 may improve photocatalytic activity of semiconductor nanocrystals 802. Changes in shape may expose different facets as reaction sites and may change the number and geometry of step edges where reactions may preferentially take place.

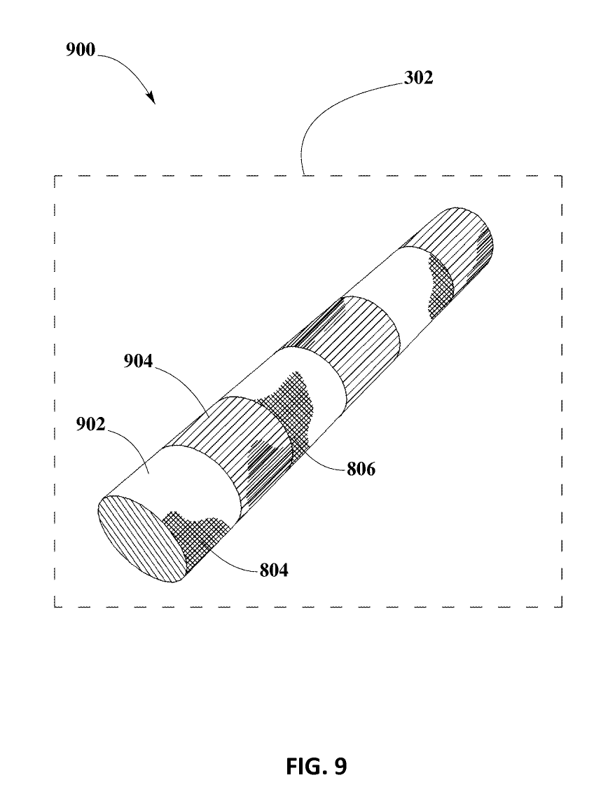

Example #2 is an embodiment of PCCN 302 in nanorod shape 900, as shown in FIG. 9. According to an embodiment, there may be three CdSe regions and four CdS regions as first semiconductor nanocrystal 902 and second semiconductor nanocrystal 904, respectively. In addition, first semiconductor nanocrystal 902 and second semiconductor nanocrystal 904 may be capped with first inorganic capping agent 804 and second inorganic capping agent 806, respectively. Each of the three CdSe first semiconductor nanocrystal 902 regions may be longer than each of the four CdS second semiconductor nanocrystal 904 regions. In other embodiments, the different regions with different materials may have the same or different lengths, and there may be any suitable number of different regions. The number of segments per nanorod in nanorod shape 900 may generally increase by increasing the length of the nanorod or decreasing the spacing between like segments.

The embodiments described above are intended to be exemplary. One skilled in the art recognizes that numerous alternative components and embodiments that may be substituted for the particular examples described herein and still fall within the scope of the invention.

What is claimed is:

1. A method for reducing carbon dioxide comprising:
forming photocatalytic capped colloidal nanocrystals, wherein each photocatalytic capped colloidal nanocrystal includes a first semiconductor nanocrystal capped with a first inorganic capping agent;
forming plasmonic nanoparticles, wherein the plasmonic nanoparticles include noble metal nanoparticles;
depositing the formed plasmonic nanoparticles onto a substrate;
depositing the formed photocatalytic capped colloidal nanocrystals on the substrate between the plasmonic nanoparticles, wherein each photocatalytic capped colloidal nanocrystal is deposited between at least two plasmonic nanoparticles;
thermally treating the substrate, the photocatalytic capped colloidal nanocrystals, and the plasmonic nanoparticles;
absorbing light with a frequency equal to or greater than a frequency of electrons oscillating against the restoring force of positive nuclei within the plasmonic nanoparticles to cause localized surface plasmon resonance, whereby the localized surface plasmon resonance creates an electric field between two adjacent plasmonic nanoparticles;
absorbing irradiated light with an energy equal to or greater than the band gap of the photocatalytic capped colloidal nanocrystals that causes electrons of the photocatalytic capped colloidal nanocrystals to migrate from the valance band of the photocatalytic capped colloidal nanocrystals into the conduction band of the photocatalytic capped colloidal nanocrystals for use in a reduction reaction, wherein the electric field prevents the electrons from recombining into the valence band of the plasmonic nanoparticles;
reacting carbon dioxide and hydrogen with the photocatalytic capped colloidal nanocrystals so that the charge carriers in the conduction band reduce carbon dioxide into methane and holes in the valence band of the photocatalytic capped colloidal nanocrystals oxidize the hydrogen into water vapor; and
collecting the methane and water using a methane permeable membrane and a water vapor-permeable membrane.

2. The method of claim 1, wherein forming photocatalytic capped colloidal nanocrystals comprises:
growing semiconductor nanocrystals by employing a template-driven seeded growth method; and
capping the semiconductor nanocrystals with an inorganic capping agent in a polar solvent to form photocatalytic capped colloidal nanocrystals.

3. The method of claim 2, wherein growing semiconductor nanocrystals by employing the template-driven seeded growth method comprises:
depositing a seed crystal on a substrate; and
growing the semiconductor nanocrystal from the seed crystal using molecular beam epitaxy or chemical beam epitaxy so that the semiconductor nanocrystal grows according to the seed crystal's structure.

4. The method of claim 2, wherein capping the semiconductor nanocrystals with an inorganic capping agent in the polar solvent to form the photocatalytic capped colloidal nanocrystals comprises:
reacting semiconductor nanocrystals precursors in the presence of an organic capping agent to form organic capped semiconductor nanocrystals;
reacting the organic capped semiconductor nanocrystals with an inorganic capping agent;
adding immiscible solvents causing the dissolution of the organic capping agents and the inorganic capping agents so that organic caps on the semiconductor nanocrystals are replaced by inorganic caps to form inorganic capped semiconductor nanocrystals; and
performing an isolation procedure to purify the inorganic capped semiconductor nanocrystals and remove the organic capping agent.

5. The method of claim 1, wherein the photocatalytic capped colloidal nanocrystals comprise a compound selected from a group consisting of ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, Fe Pt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

6. The method of claim 1, wherein a shape of the photocatalytic capped colloidal nanocrystals is chosen based on a desired wavelength of the irradiated light usable by the semiconductor nanocrystals.

7. The method of claim 1, wherein the carbon dioxide and the hydrogen are reacted with the photocatalytic capped colloidal nanocrystals in a reaction vessel, further comprising heating the reaction vessel with a heater.

8. The method of claim 1, further comprising:
transferring the water vapor to a condenser through an outlet line to obtain liquid water.

9. The method of claim 1, wherein the carbon dioxide and the hydrogen are reacted with the photocatalytic capped colloidal nanocrystals in a reaction vessel, and wherein the carbon dioxide is produced by a combustion system that is connected to the reaction vessel.

10. The method of claim 9, further comprising:
transferring the methane to the combustion system so that the methane may be used as fuel for the combustion system.

11. The method of claim 1, wherein each photocatalytic capped colloidal nanocrystals includes a second semiconductor nanocrystal capped with a second inorganic capping agent, the first inorganic capping agent acts as a reduction photocatalyst, and the second inorganic capping agent acts as an oxidation photocatalyst.

12. The method of claim 1, wherein reducing carbon dioxide into methane and oxidizing the hydrogen into water vapor comprises:
forming formic acid by combining carbon dioxide, hydrogen, and two electrons;
forming formaldehyde and water by reducing the formic acid and adding two hydrogen atoms;
forming methanol by combining the formaldehyde, two hydrogen atoms, and two electrons; and
forming methane by having the methanol accept two electrons and adding two hydrogen atoms.

13. The method of claim 1, wherein forming plasmonic nanoparticles comprises:
reducing silver nitrate with ethylene glycol in the presence of poly(vinyl pyrrolidone) to form silver nanocubes.

14. The method of claim 1, wherein forming plasmonic nanoparticles comprises:
spin coating an ethanolic solution of a SiO₂/TiO₂ precursor and poloxamer onto a Si or glass substrate;
depositing a solution of HAuCl₄ drop wise onto a surface of the Si or glass substrate to form a film; and
baking the film.

15. The method of claim 1, further comprising:
recycling unreacted water by passing the unreacted water in the reservoir back into the reaction vessel.

16. The method of claim 1, further comprising:
heating the water entering the reaction vessel so that the water boils and is in a gaseous state when reacting with the photocatalytic capped colloidal nanocrystals in the reaction vessel.

17. The method of claim 15, further comprising:
filtering the unreacted water, the hydrogen gas, and the oxygen gas leaving the reaction vessel.

18. The method of claim 1, further comprising:
passing the hydrogen gas and the oxygen gas to a fuel cell so that the fuel cell may generate electricity and water.

19. A carbon dioxide reduction system comprising:
a photoactive material comprising:
a substrate;
a plurality of plasmonic nanoparticles deposited on the substrate, wherein the plasmonic nanoparticles create an electric field between two adjacent plasmonic nanoparticles when absorbing light; and
a plurality of photocatalytic capped colloidal nanocrystals deposited on the substrate, wherein each photocatalytic capped colloidal nanocrystal is deposited between at least two plasmonic nanoparticles;
a reaction vessel housing the photoactive material and configured to receive carbon dioxide from a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb light to separate charge carriers of the photoactive material; and
a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

20. The carbon dioxide reduction system of claim 19, further comprising:
a heater that heats the reaction vessel.

21. The carbon dioxide reduction system of claim 19, wherein the water vapor permeable membrane is a polydimethylsiloxane membrane.

22. The carbon dioxide reduction system of claim 19, wherein the methane-permeable membrane is a polymide resine membrane.

23. The carbon dioxide reduction system of claim 19, further comprising:
a valve that regulates pressure and a flow rate of the carbon dioxide reduction system.

24. The carbon dioxide reduction system of claim 23, wherein the flow rate is adjusted depending on the reaction time between the carbon dioxide, hydrogen, and photoactive material.

25. The carbon dioxide reduction system of claim 19, further comprising:
a solar reflector positioned within the reaction vessel such that irradiated light that is not absorbed by the photoactive material is reflected back into the reaction vessel.

26. The carbon dioxide reduction system of claim 19, wherein each photocatalytic capped colloidal nanocrystal comprises a first semiconductor nanocrystal capped with a first inorganic capping agent.

27. The carbon dioxide reduction system of claim 26, wherein each photocatalytic capped colloidal nanocrystal further comprises a second semiconductor nanocrystal capped with a second inorganic capping agent.

28. The carbon dioxide reduction system of claim 27, wherein the first inorganic capping agent is a reduction photocatalyst and the second inorganic capping agent is an oxidation photocatalyst.

29. The carbon dioxide reduction system of claim 19, wherein at least a portion of the reaction vessel is formed of a transparent material.

30. The carbon dioxide reduction system of claim 19, further comprising:
a water condenser connected to the collector that receives the separated and collected water vapor and creates liquid water.

31. The carbon dioxide reduction system of claim 19, wherein the morphology of the photocatalytic capped colloidal nanocrystals comprises a morphology from a group consisting of a core/shell configuration, a nanowire configuration, and a nanospring configuration.

32. The carbon dioxide reduction system of claim 19, further comprising:
ligands forming a nanojunction between the plasmonic nanoparticles and the photocatalytic capped colloidal nanocrystals.

33. The carbon dioxide reduction system of claim 32, wherein each ligand includes an amine-containing compound and a ketone or alcohol containing compound.

34. The carbon dioxide reduction system of claim 19, wherein the plasmonic nanoparticles include a noble metal.

35. The carbon dioxide reduction system of claim 34, wherein the plasmonic nanoparticles are Au plasmonic nanoparticles, and the Au plasmonic nanoparticles are embedded in SiO₂/TiO₂ thin film.

36. The carbon dioxide reduction system of claim 19, wherein the electric field created between two adjacent plasmonic nanoparticles causes electrons in a valence band of the plasmonic nanoparticles to migrate to a conduction band of the photocatalytic capped colloidal nanocrystals when light contacts the plasmonic nanoparticles, and the electrons in the conduction band of the photocatalytic capped colloidal nanocrystals are used for the reduction reaction.

37. A carbon dioxide reduction system comprising:
a photoactive material comprising:
a substrate;
a plurality of plasmonic nanoparticles deposited on the substrate, wherein the plasmonic nanoparticles create an electric field between two adjacent plasmonic nanoparticles when absorbing light; and
a plurality of photocatalytic capped colloidal nanocrystals deposited on the substrate, wherein each photocatalytic capped colloidal nanocrystal is deposited between at least two plasmonic nanoparticles;
a boiler that produces carbon dioxide through a combustion reaction;
a reaction vessel housing the photoactive material and configured to receive carbon dioxide from the boiler through a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb light to separate charge carriers of the photoactive material; and
a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

38. The carbon dioxide reduction system of claim 37, wherein the carbon dioxide reduction reaction and hydrogen oxidization reaction further comprises:
forming formic acid by combining carbon dioxide, hydrogen, and two electrons;
forming formaldehyde and water by reducing the formic acid and adding two hydrogen atoms;
forming methanol by combining the formaldehyde, two hydrogen atoms, and two electrons; and
forming methane by having the methanol accept two electrons and adding two hydrogen atoms.
